(19) United States
(12) Patent Application Publication
(10) Pub. No.: US 2014/0201108 A1
(43) Pub. Date: Jul. 17, 2014

(54) METHOD AND APPARATUS FOR CALCULATING A TAX COST DIFFERENCE BETWEEN ACTUAL AND MODEL INVESTMENT PORTFOLIOS

(71) Applicants: Angela Ruth Chapman, Stanford, CA (US); Gerard Michael, Cambridge, MA (US)

(72) Inventors: Angela Ruth Chapman, Stanford, CA (US); Gerard Michael, Cambridge, MA (US)

(21) Appl. No.: 14/158,674

(22) Filed: Jan. 17, 2014

Related U.S. Application Data
(60) Provisional application No. 61/753,600, filed on Jan. 17, 2013.

(51) Int. Cl. G06Q 40/00

(52) U.S. Cl. CPC G06Q 40/10
USPC 705/36 T

(57) ABSTRACT

A method and apparatus of a device that computes the total tax cost difference between an actual client portfolio and a model portfolio is described. In an exemplary embodiment, the device receives client data corresponding to the actual portfolio and model data corresponding to the model portfolio. The device further computes the total tax cost difference between the actual portfolio and the model portfolio. To compute the total tax difference, the device computes a plurality of individual tax cost differences during a comparison time period between positions of a plurality of securities in both the actual portfolio and the model portfolio and sums the plurality of individual tax cost differences to give the total tax cost difference. In addition, the device stores the total tax cost difference in storage.

### RELATED APPLICATIONS

Applicant claims the benefit of priority of prior, co-pending provisional application Ser. No. 61/753,600, filed Jan. 17, 2013, the entirety of which is incorporated by reference.

### FIELD OF INVENTION

This invention relates generally to investment portfolio management and more particularly to calculating a tax cost difference between an actual investment portfolio and a model investment portfolio.

### BACKGROUND OF THE INVENTION

Optimal management of an individual investor's investment portfolio is difficult and time consuming. An investment portfolio is a collection of securities, where a security can be a type of financial investment (e.g., stocks, bonds, funds (e.g., money market fund, hedge fund, or another type of fund)). On an ongoing basis, the manager of an individual's investment portfolio needs to decide which trades will provide the investor with the combination of expected return and risk that is most consistent with the investor's constraints, goals and risk tolerance. This requires consideration of multiple factors, including returns, taxes, expenses and risk.

Investors and their advisors may wish to know how the performance of their portfolio differs from what might have transpired if the portfolio had been managed with less customization. In particular, investors and their advisors may wish to know if the actual portfolio had a greater tax incidence than a hypothetical comparison portfolio that was managed with less tax sensitivity.

### SUMMARY OF THE DESCRIPTION

A method and apparatus of a device that computes the total tax cost difference between an actual client portfolio and a model portfolio is described. In an exemplary embodiment, the device receives client data corresponding to the actual portfolio and model data corresponding to the model portfolio. The device further computes the total tax cost difference between the actual portfolio and the model portfolio. To compute the total tax difference, the device computes a plurality of individual tax cost differences during a comparison time period between positions of a plurality of securities in both the actual portfolio and the model portfolio and sums the plurality of individual tax cost differences to give the total tax cost difference. In addition, the device stores the total tax cost difference in storage.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 is a block diagram of one embodiment of a system to calculate a tax cost difference between an actual and a model investment portfolio.

FIG. 2 is a flowchart of one embodiment of a process to calculate a tax cost difference between an actual and a model investment portfolio.

FIG. 3 is a flowchart of one embodiment of a process to calculate a tax cost difference between an actual and a model investment portfolio for assets sold at a loss or gain.

FIG. 4 is a flowchart of one embodiment of a process to calculate a tax cost difference between an actual and a model investment portfolio for assets that have gone from unrealized short-term gains to unrealized long-term gains.

FIG. 5 is a flowchart of one embodiment of a process to calculate a tax cost difference between an actual and a model investment portfolio for over-weighted assets.

FIG. 6 is a block diagram of one embodiment of a compute held tax difference module to calculate a tax cost difference between an actual and a model investment portfolio.

FIG. 7 is a block diagram of one embodiment of a compute gain tax difference module to calculate a tax cost difference between an actual and a model investment portfolio for assets sold at a loss or gain.

FIG. 8 is a block diagram of one embodiment of a compute long-term gain tax difference module to calculate a tax cost difference between an actual and a model investment portfolio for assets that have gone from unrealized short-term gains to unrealized long-term gains.

FIG. 9 is a block diagram of one embodiment of a tax difference module to calculate a tax cost difference between an actual and a model investment portfolio for over-weighted assets.

FIG. 10 illustrates one example of a typical computer system, which may be used in conjunction with the embodiments described herein.

FIG. 11 shows an example of a data processing system, which may be used with one embodiment of the present invention.

### DETAILED DESCRIPTION

A method and apparatus of a device that computes a total tax cost difference between an actual client portfolio and a model portfolio is described. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device that computes a total tax cost difference between an actual client portfolio and a model portfolio is described. In one embodiment, the device computes a tax cost difference between an actual portfolio of a client and a model portfolio over a comparison time period. In one embodiment, the device computes this tax difference by computing tax cost differences due to held assets, sold assets, and short/long-term possibilities. For example and in one embodiment, the device computes this based on three different computations: (i) securities that are sold during the comparison time period; (ii) securities that are held and go from an unrealized short-term gain to an unrealized long-term gain during the comparison period; and (iii) over-weighted or under-weighted securities, as compared with a corresponding security in the model portfolio. The device sums the three different computations to arrive at the total tax cost difference.

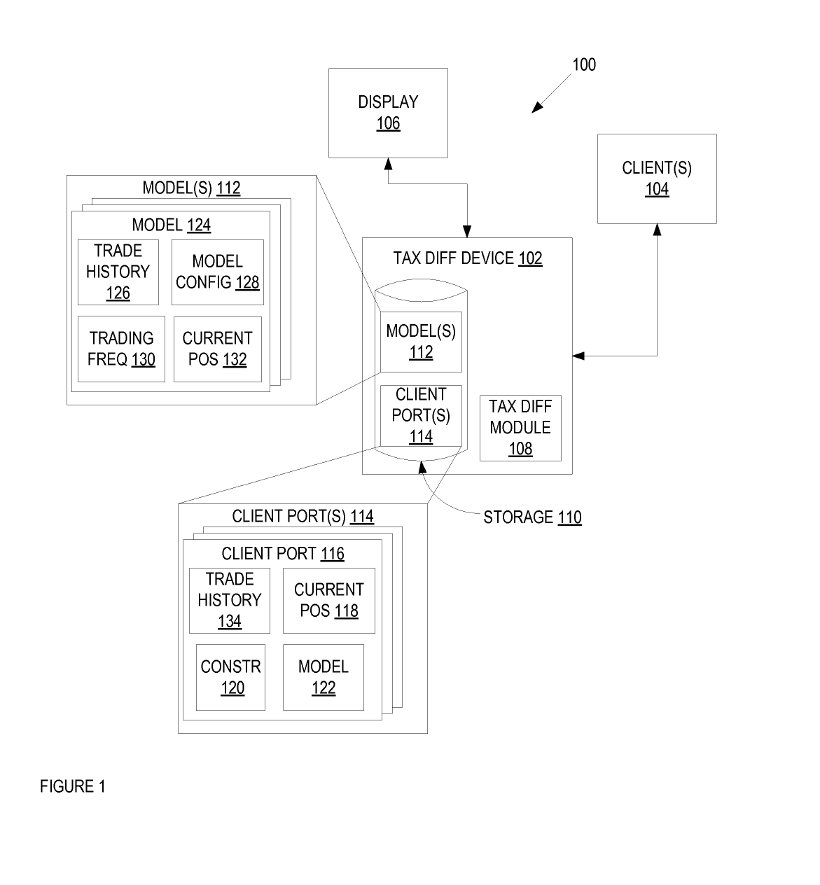

FIG. 1 is a block diagram of one embodiment of a system 100 to calculate a tax cost difference between an actual and a model investment portfolio. In FIG. 1, the system 100 includes a tax difference device 102, client(s) 104, and display 106. In one embodiment, the tax difference device 102 is a device that computes a tax difference between an actual client portfolio and a model portfolio. In one embodiment, the tax difference device 102 can be a personal computer, laptop, server, mobile device (e.g., smartphone, laptop, personal digital assistant, music playing device, gaming device, etc.), and/or any device capable of executing a process. In one embodiment, the tax difference device 102 can be a physical or virtual device.

In one embodiment, the tax difference device 102 includes a tax difference module 108 and storage 110. In this embodiment, the tax difference module 108 computes a tax cost difference between an actual client portfolio and a model portfolio over a comparison time period. In one embodiment, the comparison time period can be a fiscal year, a day, week, month, another year, and/or any other time period. In one embodiment, a portfolio is a collection of securities, where a security can be any type of financial investment (e.g., stocks, bonds, options, unit trust, foreign currency, real estate investment trust, and/or other types of funds (e.g., money market fund, hedge fund, or another type of fund)). In this embodiment, the client portfolio is a collection of securities that is owned by the client. A client may have one or more portfolios.

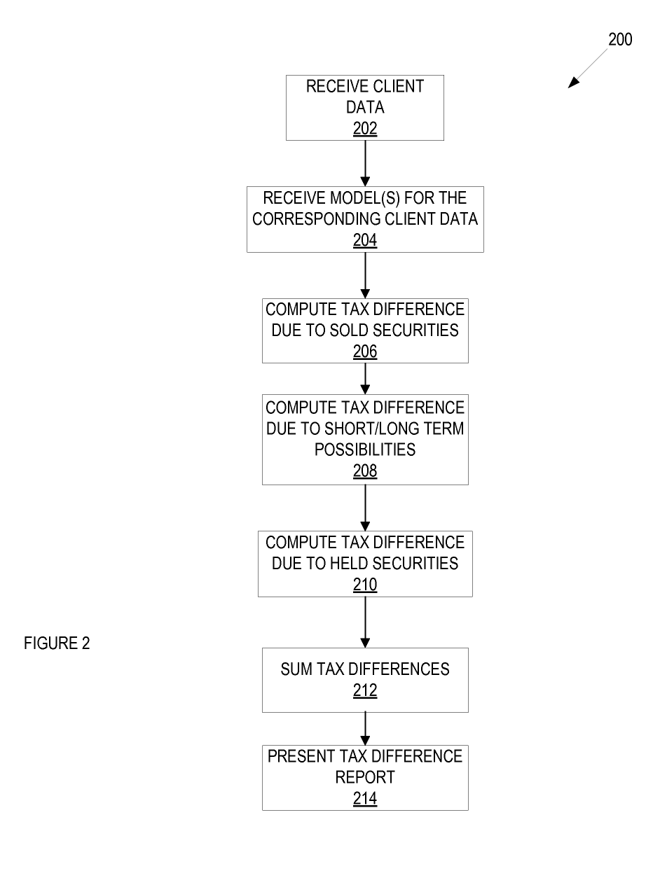

In one embodiment, the tax difference module 108 computes the tax cost difference by computing the tax cost differences of individual securities in the client's actual portfolio that are: (i) securities that are sold during the comparison time period; (ii) securities that are held and go from an unrealized short-term gain to an unrealized long-term gain during the comparison period; and (iii) over-weighted or under-weighted as compared with a corresponding security in the model portfolio. In one embodiment, this tax cost difference is done for a time period. The tax difference module 108 further sums these individual tax cost differences into a total tax cost difference and stores the total tax cost difference in memory for later use. In one embodiment, the tax difference device 102 presents the total tax cost difference on a display 106 coupled to the tax difference device 102 for a user to view. In this embodiment, the tax difference device 102 presents the total tax cost difference in a report displayed on the display 106 and may also show the individual tax cost differences for the client to view. In this embodiment, the client can use this report to compare the performance of the client's actual portfolio with the model portfolio in terms of tax cost. In another embodiment, the tax difference device 102 is a server that communicates with the client device(s) 104 to produce the total tax cost difference for the client device(s) 104. For example and in one embodiment, the tax difference device 102 is a server (e.g., a Web server) that responds to requests form the client device(s) 104 for computing the total tax cost difference and individual tax cost difference for the client. Computing the total tax cost difference is further described in FIG. 2 below.

In one embodiment, the tax difference device 102 includes storage 110. In one embodiment, the storage 110 is persistent storage that stores the data used to compute the total tax cost difference and individual tax cost difference as described above. In one embodiment, the storage 110 stores the model(s) 112 and client portfolio(s) 114. In one embodiment, the model(s) 112 are one or more different model portfolios that can be compared with the client portfolios. In this embodiment, each of the model portfolios is a weighted list of securities. In one embodiment, the model portfolio is hypothetical alternative portfolio that follows a model configuration with little or no tax sensitivity. In one embodiment, this means that the trades made to keep the model portfolio in close adherence to the model configuration are done with little or nor regard for tax implications of those trades. In another embodiment, the model portfolio can incorporate the constraints of the client's actual portfolio, so as to be a better alternative hypothetical for the client's actual portfolio. For example and in one embodiment, if the client's actual portfolio requires that stocks in tobacco never be purchased and the model configuration for that model portfolio includes tobacco stocks, the model portfolio would not include tobacco stocks and adjust the other securities pro rata or keep the amount that would have been used for the tobacco stock as cash.

In one embodiment, the model portfolio can be expressed as a collection of percentages of value or shares, and/or a combination thereof. For example and in one embodiment, the model portfolio can be expressed as “50% IBM+50% F” or “100 shares of IBM+200 shares of F.” While in one embodiment, the model portfolio is illustrated with two different securities, in alternate embodiments, the model portfolio can include more or fewer securities. In one embodiment, the model(s) 112 includes one more model portfolios 124. In this embodiment, each of the model portfolios includes trade history 126, model configuration 128, trading frequency 130, and current positions 132. In one embodiment, the trade history 126 includes the list of trades that would be made in order for the securities in the model portfolio to closely follow the model. For example and in one embodiment, if a model portfolio value has 50% of security A and 50% of security B and the market value of securities A and B fluctuate, a close adherence to the model configuration 128 would mandate a trading of securities A and B in order to have the model portfolio value of 50% each for securities A and B. The trade history 126 of this model portfolio 124 would be a record on the trades made in order to have a close adherence to the model configuration 128.

In one embodiment, the model configuration 128 is the target for the model portfolio 124. In one embodiment, a target for the model portfolio is a set of recommended security allocations for the portfolio. For example and in one embodiment, the model configuration 128 could have 50% in large capitalization securities, 25% international small capitalization securities, and 25% medium capitalization securities. Furthermore, the large capitalization securities could be further divided up into a percentage for “Model A Large Cap Equity Value” securities and “Model B Large Cap Equity Value” securities. In addition, the “Model A Large Cap Equity Value” securities have two securities associated with it, “Blue Chip Stock” investment assets and “Mutual Fund” investment assets. In one embodiment, the trading frequency 130 is the time period that is used to review the current holdings of the model portfolio and perform trades of the current positions 132 of the model portfolio 124 in order to have a close adherence to the model configuration 128. The device can alter trading frequency 130 that is used to review the current positions 132. In one embodiment, the current position 132 represents the current positions of each security in the model portfolio 124.

In one embodiment, the client portfolio(s) 114 includes one or more different client portfolios 116 for one or more clients. In this embodiment, each client portfolio 116 includes trade history 134, current positions 118, constraints 120, and model 122. In one embodiment, the trade history 134 is the list of trades made for this client portfolio 116 that have been made over a time period. In one embodiment, the current positions 118 are the current positions of each of the securities in the client portfolio. For example and in one embodiment, the current position 118 of the client portfolio 116 could be could have 60% in large capitalization securities, 5% international small capitalization securities, and 35% medium capitalization securities. Furthermore, the large capitalization securities could be further divided up into a percentage for “Model A Large Cap Equity Value” securities and “Model B Large Cap Equity Value” securities. In addition, the “Model A Large Cap Equity Value” securities have two securities associated with it, “Blue Chip Stock” investment assets and “Mutual Fund” investment assets. In one embodiment, the model 122 is the model portfolio that the client portfolio 116 is using for tax cost comparisons.

In one embodiment, the constraints 120 are a set of conditions imposed by the client for the client portfolio 116. These constraints may be: an exclusion of a type of security in the client portfolio; an imposition for a security to be included in the portfolio; a limit on turnover (the amount of trading), a limit on total tax obligation, a limit on the expected “yield” of the portfolio (dividends plus interest), and/or a limit to the amount of a type of security in the portfolio. For example, the client may require that their IBM stock never be sold, stocks in tobacco companies never be purchased, no more than 20% of their portfolio be invested in bonds, no more than 10% of any portfolio be invested in foreign securities, or that the portfolio is to invest in only a limited group of securities (e.g., those stocks that are part of the S&P 500). In one embodiment, the device 102 uses the constraints to alter how the tax cost difference computation is performed. For example and in one embodiment, if a certain class of security is excluded by the client (e.g., never buy tobacco stocks), the rest of the securities percentages in the model portfolios are raised pro-rata. The effect of constraints is further discussed in FIG. 2 below.

As described above, FIG. 2 is a flowchart of one embodiment of a process 200 to calculate a tax cost difference between an actual and a model investment portfolio. In one embodiment, process 200 is performed by a tax difference module to calculate the tax cost difference between an actual and a model investment portfolio, such as the tax difference module 108 as described in FIG. 1 above. In FIG. 2, process 200 begins by receiving the client data at block 202. In one embodiment, the client data is the data associated with the client portfolio that is used to compute the tax cost difference. For example and in one embodiment, the client data is the client portfolio 116 as described in FIG. 1 above. At block 204, process 200 receives the model portfolio that corresponds to the client data. In one embodiment, the model portfolio is the model portfolio as indicated in the client data as described in FIG. 1 above.

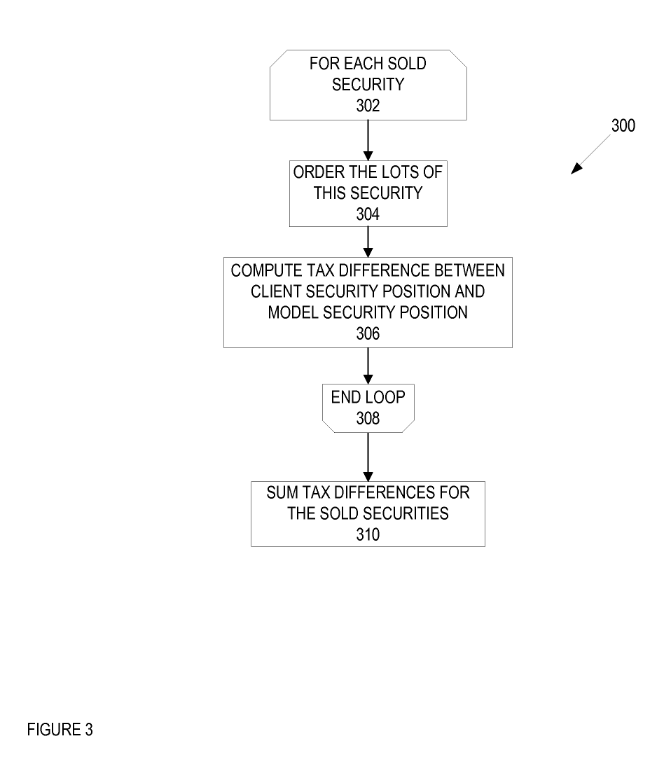

As described above, the total tax cost difference between the actual and model portfolios can be computed based on three different computations: (i) securities that are sold during the comparison time period; (ii) securities that are held and go from an unrealized short-term gain to an unrealized long-term gain during the comparison period; and (iii) securities deemed over-weighted or under-weighted compared to a corresponding security in the model portfolio. At block 206, process 200 computes the tax cost difference due to sold assets during the comparison time period. In one embodiment, the comparison time period can be a fiscal year, a day, week, month, another year, and/or any other time period. For example and in one embodiment, process 200 can compare the tax cost difference for sold assets over the previous tax year. In one embodiment, process 200 computes the tax cost difference by determining which of the securities in the actual and/or model portfolios were sold at a loss during the comparison time period. For example and in one embodiment, process 200 determines the difference of a position of one security in the actual portfolio sold at a loss and the position of that security in the model portfolio. If the actual security position is less than the model security position, the tax cost difference is a tax credit. Computing the tax cost difference for sold securities is further described in FIG. 3 below.

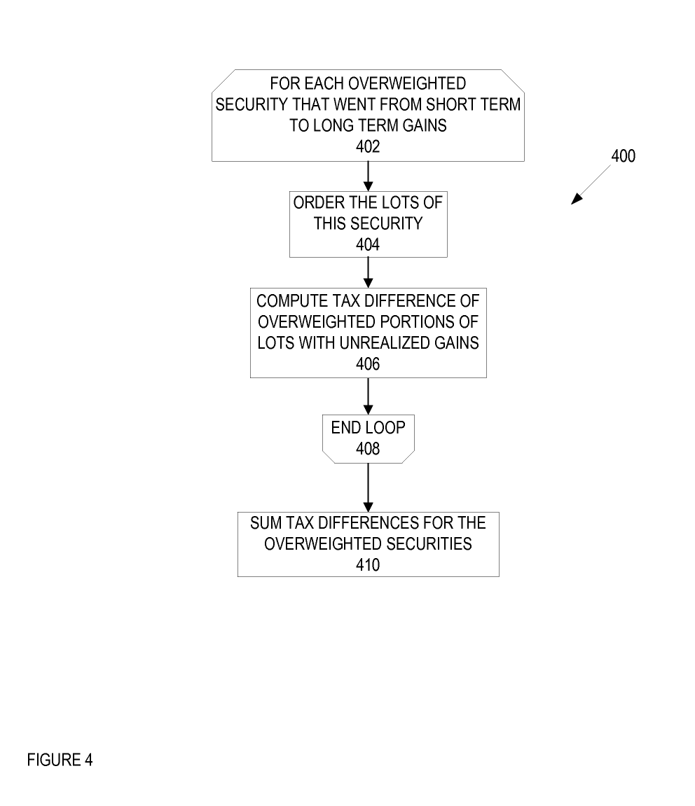

At block 208, process 200 computes the tax cost difference between an actual and a model investment portfolio for securities that have gone from unrealized short-term gains to unrealized long-term gains. In one embodiment, process 200, for each position and security, sums across the short-term lots of a security that went long-term with an unrealized gain since the beginning of the year. In this embodiment, process 200 determines the difference between the short and long-term gain rates and the unrealized gains associated with the portion of the position that was above target. For example and in one embodiment, if a security in the actual portfolio has a security that has unrealized long-terms gains starting in the comparison time period, process 200 computes this tax cost difference as a tax credit. Computing the tax cost difference for securities that have gone from unrealized short-term gains to unrealized long-term gains is further described in FIG. 4 below.

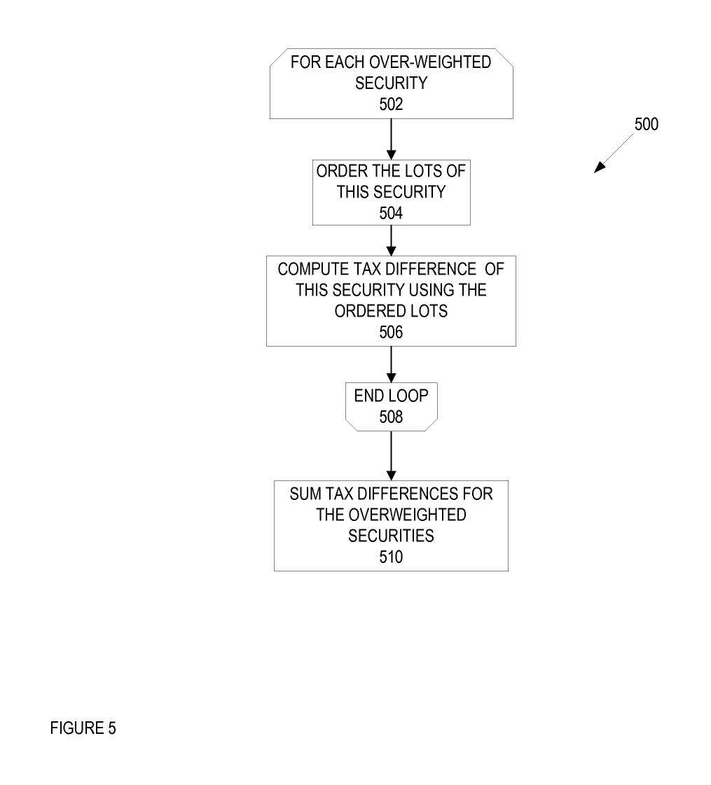

Process 200 computes the tax difference due to held securities at block 210. In one embodiment, process 200, for the gain positions in the actual portfolio, sums the taxes that would result from selling the position to target weight in that model portfolio. For example and in one embodiment, process 200 determines the difference between an over-weighted security and the target security in the corresponding model portfolio and computes a tax credit for that security. Computing the tax cost difference for sold securities is further described in FIG. 5 below.

As described above, process 200 can use constraints to alter how the tax cost difference computation is performed. In one embodiment, process 200 uses the constraints to change the percentages of the securities used in each of the computations. For example and in one embodiment, if a certain class of security is excluded by the client (e.g., never buy tobacco stocks), the rest of the securities percentages in the model portfolios are raised pro-rata. Or if a security is not to be sold (e.g., never sell petroleum stocks), the rest of the security percentages of the client's portfolio are raised pro-rata.

At block 212, process 200 sums the tax cost differences computed at block 206, 208, and 210 to give a total tax cost difference. In one embodiment, process 200 stores the total tax cost difference in persistent storage, so that the total tax cost difference can be retrieved later. For example and in one embodiment, process 200 stores the total tax cost difference in the persistent storage of the tax difference device 102 as described in FIG. 1 above. Process 200 presents the total tax cost difference in a report at block 214. In one embodiment, The results of the above described calculation can be presented to an investor, for example, in a report format such as the following:

TABLE 1
Sample Tax Cost Difference Report
Tax Cost Difference

| Comparison Time period | Jan. 1, 2012-Dec. 19, 2012 |
|---|---|
| Total Tax Cost Difference | $76,000 |
| Held Securities | $31,000 |
| Holding Short Until Long | $10,000 |
| Sold Securities | $35,000 |

As described above, process 200 determines a tax cost difference based on sold assets. FIG. 3 is a flowchart of one embodiment of a process to calculate a tax cost difference between an actual and a model investment portfolios for securities sold at a loss or gain. In one embodiment, process 300 is performed by a process to compute the tax cost difference for securities sold, such as process 200 as described above in FIG. 2 at block 206. In FIG. 3, process 300 begins by performing a processing loop (blocks 302-308) over the sold securities of the actual portfolio to determine tax cost differences for these sold assets. At block 304, process 300 orders the lots of this security. In one embodiment, the client portfolio may include one or more lots for a given security. Each of these lots may have different purchase dates and can results in different tax rates (e.g., short or long-term gains tax rates). In this embodiment, process 300 orders the lots so as to favor the tax computations towards the model portfolio, the actual portfolio, or both. For example and in one embodiment, process 300 orders the lots to favor the model portfolio in order of a tax-cost per unit liquidated. In this embodiment, the tax cost differences could be less than if the lots are ordered to favor the actual portfolio. In one embodiment, the tax lots are randomly distributed or are balanced between the actual and model portfolios. For example and in one embodiment, when there are multiple lots making up a position for a security, process 300 may arrange these lots so as to provide the least credit. In this example, process 300 uses the most tax-advantageous lots first. So, in this example, process 300 orders the lots to be sold in a way that gives the least tax credit (e.g., in order of descending tax loss harvesting value).

At block 306, process 300 computes the tax cost difference for this sold asset between the actual client portfolio position and the model portfolio position. In one embodiment, the tax cost difference is a tax saving if a position of the security in the actual portfolio is brought to a value lower than the corresponding position in the model portfolio, and a portion of the sale between the level of the corresponding position in the model portfolio and the position in the actual portfolio after the sale is at a tax-loss. In another embodiment, the tax cost difference is a tax cost if a position of the security in the actual portfolio is brought to a value lower than the corresponding position in the model portfolio, and a portion of the sale between the level of the corresponding position in the model portfolio and position in the actual portfolio after the sale is at a tax-gain.

In one embodiment, process 300 sums, since the start of the comparison time period, across the sales at a loss, of the product at the appropriate tax rate (e.g. short or long), and the realized loss that was associated with selling below target. In one embodiment, the phrase ‘associated with selling below target’ means the system only credits selling something below target weight. Process 300 may not, for example, credit loss harvesting for selling an over-weighted position to target weight. If an over-weighted position is sold to, say, 0, process 300 may only credit the portion of the sale that brought the position below target weight.

For example and in one embodiment, assume that the tax rate is 35%, the target weight is $10,000, the beginning weight of tax lot is $15,000, and the basis is $30,000. Furthermore, in this example, the loss per dollar sold is $0.50, the sale amount is $8,000, and end weight is $7,000, with the total realized loss being $4,000. In this example, process 300 would compute that the portion of sale that was below target is $3,000 and realized loss on this portion is $1,500. The tax saved is 0.35*$1,500 or $525. In this example, the individual tax cost difference would be a credit of $525.

In one embodiment, the inputs for each date in the comparison time period represent exported or executed sales. Taxes saved from loss harvesting can be calculated using the realized loss, if any, for each sell lot using: the basis price per share; execution price of the sale; and number of shares sold. If there are exported realized losses, the process 300 can identify the (i) short and long loss rates and, for each position with at least one realized loss, (ii) the target value for that position (e.g., a rescaled target percentage times total account value based on market close prices), and (iii) information for each lot in the position, in order to determine whether the final position was underweight and to calculate lot ordering for the taxes-saved algorithm. For each lot, process 300 can identify basis price per share, actual sale price per share (if sold; price at market close if not sold), number of shares sold (if any), and purchase date. In one embodiment, process 300 may use the ‘true’ short loss rate or a more conservative default (i.e., 35% or 15%).

In another embodiment, process 300 computes the tax difference due to selling a security below the target at a gain at block 306. In this embodiment, process 300, since the starting of the comparison time period, sums across all sales of the security at a gain the loss tax rate (e.g. short or long) times the realized gain that was associated with selling below target. In one embodiment associated with selling below the target means, process 300 penalizes for selling the security below target weight. Effectively, this is the opposite of selling below the target at a loss. For example and in one embodiment, assume the tax rate is 35%, the target weight is $10,000, where the beginning weight of tax lot is $15,000 and the basis is $7,500. In this example, the gain per dollar sold is $0.50, the sale amount is $8,000 and the end weight is $7,000. In addition, the total realized gain is $4,000. The portion of sale that was below target is $3,000, with the realized gain on this portion being $1,500. In this example, the tax cost introduced is 0.35*$1,500 or $525. In this example, the individual tax cost difference would be a penalty of $525.

In the embodiment of selling a security below the target at a gain, process 300, for each date in the comparison time period with exported sales, identifies: (i) a realized gain, if any, for each sell lot of this security (which includes the basis price per share, estimated sale price per share, and number of shares sold); and (ii) if there are exported realized gains, for each position with at least one realized gain. Process 300 further identifies the short and long loss rates and the target value for that position (rescaled target percentage times total account value based on market close prices) and information for each lot of the position so that the system can determine whether the final position was underweight. Process 300 also determines lot ordering for the taxes-saved algorithm. For each lot, process 300 identifies the basis price per share, actual sale price per share (if sold; price at market close if not sold), number of shares sold (if any), and purchase date. In one embodiment, these calculations do not assume that any current, non-exported recommendations are being acted upon; they only incorporate account history and current holdings information. The processing loop ends at block 308.

At block 310, process 300 sums the individual tax cost difference computed in the processing loop above to give the total tax cost difference. In one embodiment, the summed individual tax cost differences is used by process 200 in FIG. 2 to determine the total tax cost difference.

As described above, process 200 determines a tax cost difference based on assets that have gone from unrealized short-term gains to unrealized long-term gains. FIG. 4 is a flowchart of one embodiment of a process 400 to calculate a tax cost difference between an actual and a model investment portfolio for assets that have gone from unrealized short-term gains to unrealized long-term gains. In one embodiment, process 400 is performed by a process to compute the tax cost difference for assets that have gone from unrealized short-term gains to unrealized long-term gains, such as process 200 as described above in FIG. 2 at block 208. In FIG. 4, process 400 begins by performing a processing loop (blocks 402-408) over the over-weighted securities of the actual portfolio to determine tax cost differences for assets that have gone from unrealized short-term gains to unrealized long-term gains. At block 404, process 400 orders the lots of this security. In one embodiment, process 400 orders the lots so as to favor the tax computations towards the model portfolio, the actual portfolio, or both. For example and in one embodiment, process 400 orders the lots to favor the model portfolio. In this embodiment, the tax cost differences could be less than if the lots are ordered to favor the actual portfolio. In one embodiment, the tax lots are randomly distributed or are balanced between the actual and model portfolios. For example and in one embodiment, when there are multiple lots making up a position for a security, process 400 may arrange these lots so as to provide the least credit. In this example, process 400 uses the most tax-advantageous lots first. In this example, if there were two equal lots, one with short gains and the other with a loss, and only jointly were they over-weighted, process 400 would give no credit for tax savings since the user could have brought the position to target weight without realizing short-term gains.

At block 406, process 400 computes an individual tax cost difference for a security with over-weighted portions of lots with unrealized gains that went from short-term to long-term gains. In one embodiment, the tax cost difference is a tax saving if a position of that security in the actual portfolio is larger than the corresponding position in the model portfolio, the over-weight portion of the position is at taxable gain in the beginning of the comparison period, the over-weight portion of the position has a lower applicable tax rate at the end of the comparison period, and the over-weight portion of the position is not sold during the comparison period. In another embodiment, the tax cost difference is a tax cost if a position in the actual portfolio is larger than the corresponding position in the model portfolio, the over-weight portion of the position is at taxable gain in the beginning of the comparison period, the over-weight portion of the position has a higher applicable tax rate at the end of the comparison period, and the over-weight portion of the position is not sold during the comparison period.

In one embodiment, process 400 sums, across the short-term lots that went long-term with an unrealized gain since the beginning of the comparison time period, the difference between the short and long-term gain rates and the unrealized gains associated with the portion of the position that was above target.

For example and in one embodiment, assume that the short-term tax rate is 35%, the long-term tax rate is 15%, which leads to a tax rate difference of 20%. Furthermore, in this example, the target weight is $10,000, the weight of position is $15,000, and the basis is $10,000. This leads to an unrealized gain per dollar held of $0.33. From the input data, the portion of position that was above target is $5,000, which leads to an unrealized gain on this portion of $1,650. In this example, the taxes credited is 20%*$1,650 or $330. In this example, the individual tax cost difference would be a credit of $330.

As another example and embodiment, assume there are multiple lots of security X, which has a target weight of $10,000. The short to long rate difference is 20%. In this example, Lot #1 was short-term on Jan. 1 this year, went long yesterday, has a basis of $8,000, and is currently worth $11,000 (Gain per dollar held=$0.27). Lot #2 was long-term on Jan. 1 this year, has a basis of $900, and has a current value of $1,000. The total overweight amount of this position: ($11,000+$1,000−$10,000)=$2,000. However, $1,000 of this could be due to the lot that was long all year. So the amount of credit process 400 takes for taxes credited is ($2,000−$1,000)*0.27*20% or $54.00.

In one embodiment, process 400 can identify and sum the following for each business day in the comparison time period: basis price; price at market close; and purchase date of each short-term lot, if any (to determine which short lots are held at a gain). In addition, for each short-term lot that is a gain, process 400 can identify the date on which any short-term lots at a gain will go long. In addition, if any short lots at a gain will go long on or prior to the next business day (taking weekends and holidays into consideration), the system can identify: short and long-term gain rates; lot information for the position, in order to determine lot ordering and whether the position is overweight (for each lot: basis price, price at market close, number of shares, purchase date); and target percentage for the position and total current portfolio value at market close, in order to determine whether the position is overweight. The processing loop ends at block 408. In one embodiment, a security could be sold with a short-term gain that is below a target weight. In this embodiment, process 400 determines a tax penalty for selling the security that has the short-term gain below the target weight.

At block 410, process 400 sums the individual tax cost difference computed in the processing loop above to give the total tax cost difference. In one embodiment, the summed individual tax cost differences is used by process 200 in FIG. 2 to determine the total tax cost difference.

As described above, process 200 determines a tax cost difference based on over-weighted assets. FIG. 5 is a flowchart of one embodiment of a process 500 to calculate a tax cost difference between an actual and a model investment portfolio for over-weighted assets. In one embodiment, process 500 is performed by a process to compute the tax cost difference for over-weighted assets, such as process 200, as described above in FIG. 2 at block 210. In FIG. 5, process 500 begins by performing a processing loop (blocks 502-508) of over-weighted securities. At block 504, process 500 orders the lots of this security. In one embodiment, process 500 orders the lots so as to favor the tax computations towards the model portfolio, the actual portfolio, or both. For example and in one embodiment, process 500 orders the lots to favor the model portfolio. In this embodiment, the tax cost differences could be less than if the lots are ordered to favor the actual portfolio. In one embodiment, the tax lots are randomly distributed or are balanced between the actual and model portfolios. For example and in one embodiment, when there are multiple lots making up a position for a security, process 500 may arrange these lots so as to provide the least credit. In this example, process 500 uses the most tax-advantageous lots first.

At block 506, process 500 computes the individual tax cost difference for the over-weighted securities. In one embodiment, process 500 sums the taxes that would result from selling the position of the over-weighted to target weight in the model portfolio. In this embodiment, this would result in a tax saving. In this embodiment, process 500 identifies for computation: (i) short and long gain rates; (ii) information to determine whether each lot is at a gain and whether it is short or long (e.g., basis price, current price, purchase date); and (iii) information to determine whether any positions are overweight (e.g., rescaled target percentage for each position and total portfolio value). For example and in one embodiment, assume that the tax rate is 35%, the target weight is $10,000, the value of the tax lot is $15,000, and the basis is $7,500. In this example, the gain per dollar sold is $0.50, and the amount overweight is $5,000, of which $5,000*$0.50=$2,500 is unrealized gain. By maintaining this overweight, the tax saved is 0.35*$2,500=$875. The processing loop ends at block 508.

At block 510, process 500 sums the individual tax cost difference computed in the processing loop above to give the total tax cost difference. In one embodiment, the summed individual tax cost differences is used by process 200 in FIG. 2 to determine the total tax cost difference.

Another way to calculate taxes saved (and other tax measures such as tax alpha) is to take the difference in various measures (such as pre-tax returns, post-tax returns and tax obligations) between two portfolios: a) a client's actual portfolio and b) a “what if” shadow portfolio that was managed in a non-tax sensitive manner (e.g., in the “what if” portfolio, your starting holdings, if not cash, would be sold off and the holdings in the model would be purchased). Thereafter, the non-tax sensitive “what-if” portfolio would be rebalanced frequently to make sure its holdings match up exactly with the model). For taxes saved, a system would compute the difference between these two portfolios in taxes due on a) realized gains/losses (including mutual fund capital gains distributions) and b) dividends.

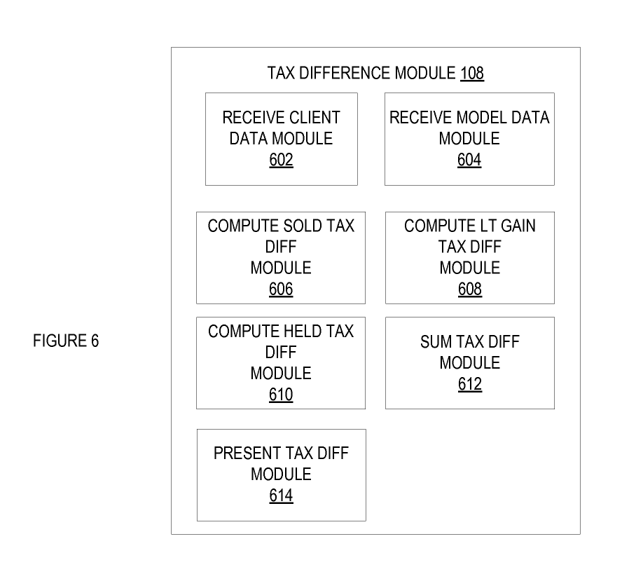

FIG. 6 is a block diagram of one embodiment of a tax difference module 108 to calculate a tax cost difference between an actual and a model investment portfolio. In one embodiment, the tax difference module 108 includes a receive client data module 602, receive model data module 604, compute sold tax difference module 606, compute long-term gain tax difference module 608, compute held tax difference module 610, sum tax difference module 612, and present tax difference module 614. In one embodiment, the receive client data module 602 receives the client data as described in FIG. 2, block 202 above. The receive model data module 604 receives the model data as described in FIG. 2, block 204 above. The compute sold tax difference module 606 computes the sold security tax difference as described in FIG. 2, block 206 above. The compute long-term gain tax difference module 608 computes the unrealized long-term gains tax difference as described in FIG. 2, block 208 above. The compute held tax difference module 610 computes the held securities tax difference as described in FIG. 2, block 210 above. The sum tax difference module 612 sums the tax differences as described in FIG. 2, block 212 above. The present tax difference report module 614 presents the tax difference report as described in FIG. 2, block 214 above.

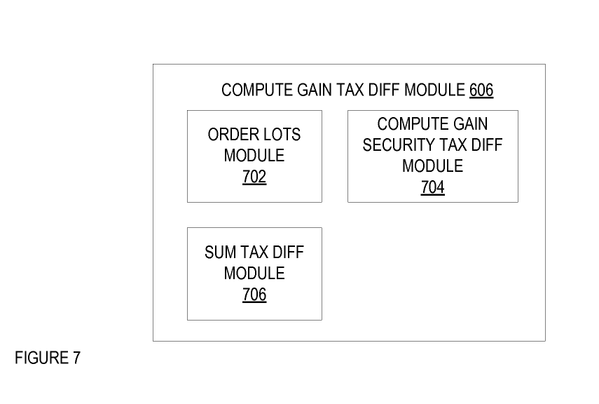

FIG. 7 is a block diagram of one embodiment of a compute gain tax difference module 606 to calculate a tax cost difference between an actual and a model investment portfolio for assets sold at a loss or gain. In one embodiment, the compute gain tax difference module 606 includes an order lots module 702, compute gain security tax difference module 704, and sum tax differences module 706. In one embodiment, the order lots module 702 orders the lots of the security as described in FIG. 3, block 304 described above. The compute gain security tax difference module 704 computes the individual tax cost difference as described in FIG. 3, block 306 described above. The sum tax differences module 706 sums the individual tax cost difference as described in FIG. 3, block 310 described above.

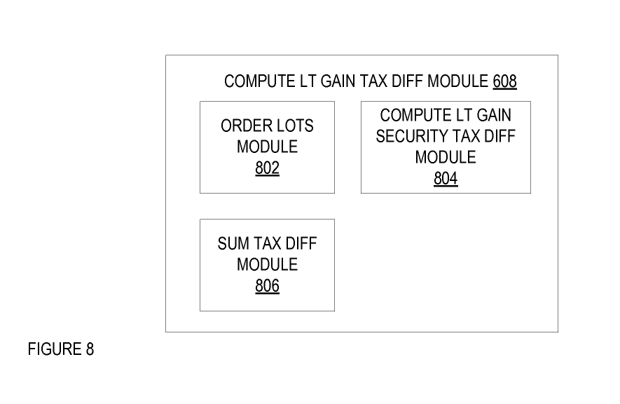

FIG. 8 is a block diagram of one embodiment of a compute long-term gain tax difference module 608 to calculate a tax cost difference between an actual and a model investment portfolio for assets that have gone from unrealized short-term gains to unrealized long-term gains. In one embodiment, the compute gain tax difference module 608 includes an order lots module 802, compute long-term gain security tax difference module 804, and sum tax differences module 806. In one embodiment, the order lots module 802 orders the lots of the security as described in FIG. 4, block 404 described above. The compute long-term gain security tax difference module 804 computes the individual tax cost difference as described in FIG. 4, block 406 described above. The sum tax differences module 806 sums the individual tax cost difference as described in FIG. 4, block 410 described above.

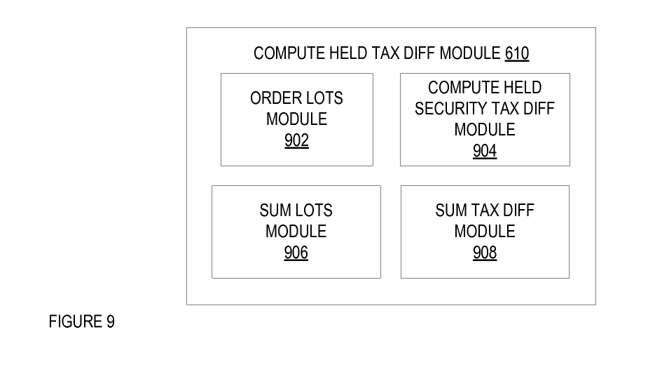

FIG. 9 is a block diagram of one embodiment of a compute held tax difference module 610 to calculate a tax cost difference between an actual and a model investment portfolio for under or over-weighted assets. In one embodiment, the compute held tax difference module 610 includes an order lots module 902, compute held security tax difference module 904, sum lots module 906, and sum tax differences module 908. In one embodiment, the order lots module 902 orders the lots of the security as described in FIG. 5, block 504 described above. The compute gain security tax difference module 904 computes the individual tax cost difference as described in FIG. 5, block 506 described above. The sum lots module 906 sums the lots as described in FIG. 5, block 508 described above. The sum tax differences module 908 sums the individual tax cost difference as described in FIG. 5, block 512 described above.

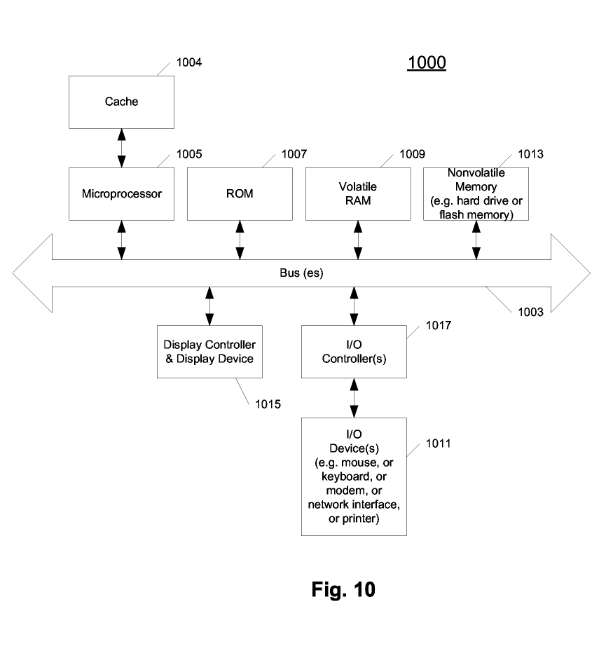

FIG. 10 shows one example of a data processing system 1000, which may be used with one embodiment of the present invention. For example, the system 1000 may be implemented including a device 102 as shown in FIG. 1 above. Note that while FIG. 10 illustrates various components of a computer system, it is not intended to represent any particular architecture or manner of interconnecting the components as such details are not germane to the present invention. It will also be appreciated that network computers and other data processing systems or other consumer electronic devices, which have fewer components or perhaps more components, may also be used with the present invention.

As shown in FIG. 10, the computer system 1000, which is a form of a data processing system, includes a bus 1003 which is coupled to a microprocessor(s) 1005 and a ROM (Read Only Memory) 1007 and volatile RAM 1009 and a non-volatile memory 1011. The microprocessor 1005 may retrieve the instructions from the memories 1007, 1009, 1011 and execute the instructions to perform operations described above. The bus 1003 interconnects these various components together and also interconnects these components 1005, 1007, 1009, and 1011 to a display controller and display device 1015 and to peripheral devices such as input/output (I/O) devices which may be mice, keyboards, modems, network interfaces, printers and other devices which are well known in the art. Typically, the input/output devices 1015 are coupled to the system through input/output controllers 1017. The volatile RAM (Random Access Memory) 1009 is typically implemented as dynamic RAM (DRAM), which requires power continually in order to refresh or maintain the data in the memory.

The mass storage 1013 is typically a magnetic hard drive or a magnetic optical drive or an optical drive or a DVD RAM or a flash memory or other types of memory systems, which maintain data (e.g. large amounts of data) even after power is removed from the system. Typically, the mass storage 1013 will also be a random access memory although this is not required. While FIG. 10 shows that the mass storage 1013 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 1003 may include one or more buses connected to each other through various bridges, controllers and/or adapters as is well known in the art.

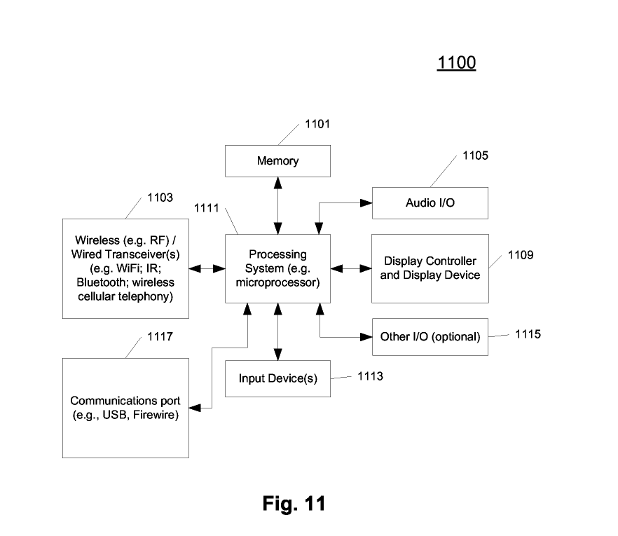

FIG. 11 shows an example of another data processing system 1100 which may be used with one embodiment of the present invention. For example, system 1100 may be implemented as a device 400 as shown in FIG. 4. The data processing system 1100 shown in FIG. 11 includes a processing system 1111, which may be one or more microprocessors, or which may be a system on a chip integrated circuit, and the system also includes memory 1101 for storing data and programs for execution by the processing system. The system 1100 also includes an audio input/output subsystem 1105, which may include a microphone and a speaker for, for example, playing back music or providing telephone functionality through the speaker and microphone.

A display controller and display device 1109 provide a visual user interface for the user; this digital interface may include a graphical user interface which is similar to that shown on a Macintosh computer when running OS X operating system software, or Apple iPhone when running the iOS operating system, etc. The system 1100 also includes one or more wireless transceivers 1103 to communicate with another data processing system, such as the system 1000 of FIG. 10. A wireless transceiver may be a WLAN transceiver, an infrared transceiver, a Bluetooth transceiver, and/or a wireless cellular telephony transceiver. It will be appreciated that additional components, not shown, may also be part of the system 1100 in certain embodiments, and in certain embodiments fewer components than shown in FIG. 11 may also be used in a data processing system. The system 1100 further includes one or more communications ports 1117 to communicate with another data processing system, such as the system 1000 of FIG. 10. The communications port may be a USB port, Firewire port, Bluetooth interface, etc.

The data processing system 1100 also includes one or more input devices 1113, which are provided to allow a user to provide input to the system. These input devices may be a keypad or a keyboard or a touch panel or a multi touch panel. The data processing system 1100 also includes an optional input/output device 1115 which may be a connector for a dock. It will be appreciated that one or more buses, not shown, may be used to interconnect the various components as is well known in the art. The data processing system shown in FIG. 11 may be a handheld computer or a personal digital assistant (PDA), or a cellular telephone with PDA like functionality, or a handheld computer which includes a cellular telephone, or a media player, such as an iPod, or devices which combine aspects or functions of these devices, such as a media player combined with a PDA and a cellular telephone in one device or an embedded device or other consumer electronic devices. In other embodiments, the data processing system 1100 may be a network computer or an embedded processing device within another device, or other types of data processing systems, which have fewer components or perhaps more components than that shown in FIG. 11.

At least certain embodiments of the inventions may be part of a digital media player, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more music or audio files, still pictures, and/or video.

The portable media player may include a media selection device, such as a click wheel input device on an iPod® or iPod Nano® media player from Apple, Inc. of Cupertino, Calif., a touch screen input device, pushbutton device, movable pointing input device or other input device. The media selection device may be used to select the media stored on the storage device and/or the remote storage device. The portable media player may, in at least certain embodiments, include a display device which is coupled to the media processing system to display titles or other indicators of media being selected through the input device and being presented, either through a speaker or earphone(s), or on the display device, or on both display device and a speaker or earphone(s). Examples of a portable media player are described in published U.S. Pat. No. 7,345,671 and U.S. published patent number 2004/0224638, both of which are incorporated herein by reference.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “computing,” “summing,” “determining,” “sending,” “returning,” “storing,” “saving,” “ordering,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A non-transitory machine-readable medium having executable instructions to cause one or more processing units to perform a method to compute a total tax cost difference between an actual portfolio of a client and a model portfolio, the method comprising:
receiving client data corresponding to the actual portfolio and model data corresponding to the model portfolio;
computing the total tax cost difference during a comparison time period between the actual portfolio and the model portfolio by,
computing a plurality of individual tax cost differences between positions of a plurality of securities in the actual portfolio and the model portfolio, and
summing the plurality of individual tax cost differences to give the total tax cost difference; and
storing the total tax cost difference in persistent storage.

2. The non-transitory machine-readable medium of claim 1, wherein the computing the total tax cost difference further comprises:
ordering a plurality of lots of one of the plurality of securities in order of a tax-cost per unit liquidated.

3. The non-transitory machine-readable medium of claim 1, wherein the computing a plurality of individual tax cost differences further comprises:
computing the individual tax cost difference for each over-weighted security in the plurality of securities, wherein an over-weighted security is a security that has a greater position in the actual portfolio than in the model portfolio.

4. The non-transitory machine-readable medium of claim 1, wherein the individual tax cost difference is a tax saving if that security has a position that would incur capital gains if liquidated down to a corresponding position in the model portfolio.

5. The non-transitory machine-readable medium of claim 1, wherein the computing a plurality of individual tax cost difference further comprises:
computing an individual tax cost difference for each security in the plurality of securities sold during the comparison time period.

6. The non-transitory machine-readable medium of claim 5, wherein the individual tax cost difference is a tax saving if a position of the security in the actual portfolio is brought to a value lower than the corresponding position in the model portfolio, and a portion of the sale between the level of the corresponding position in the model portfolio and the position in the actual portfolio after the sale is at a tax-loss.

7. The non-transitory machine-readable medium of claim 5, wherein the individual tax cost difference is a tax cost if a position of the security in the actual portfolio is brought to a value lower than the corresponding position in the model portfolio, and a portion of the sale between the level of the corresponding position in the model portfolio and position in the actual portfolio after the sale is at a tax-gain.

8. The non-transitory machine-readable medium of claim 1, wherein the computing a plurality of individual tax cost difference further comprises:
computing an individual tax cost difference for each security in the plurality of securities that undergoes a change of applicable tax-rate during the comparison period.

9. The non-transitory machine-readable medium of claim 8, wherein the individual security tax cost difference is a tax saving if a position of that security in the actual portfolio is larger than the corresponding position in the model portfolio, the over-weight portion of the position is at taxable gain in the beginning of the comparison period, the over-weight portion of the position has a lower applicable tax rate at the end of the comparison period, and the over-weight portion of the position is not sold during the comparison period.

10. The non-transitory machine readable medium of claim 8, wherein the computing of individual security tax cost difference is a tax cost if a position in the actual portfolio is larger than the corresponding position in the model portfolio, the over-weight portion of the position is at taxable gain in the beginning of the comparison period, the over-weight portion of the position has a higher applicable tax rate at the end of the comparison period, and the over-weight portion of the position is not sold during the comparison period.

11. The non-transitory machine readable medium of claim 1, wherein the model portfolio adheres to model configuration without regard to tax implications and the model configuration is a target portfolio for the model portfolio.

12. A computerized method to compute a total tax cost difference between an actual portfolio of a client and a model portfolio, the method comprising:
receiving client data corresponding to the actual portfolio and model data corresponding to the model portfolio;
computing the total tax cost difference during a comparison time period between the actual portfolio and the model portfolio by,
computing a plurality of individual tax cost differences between positions of a plurality of securities in the actual portfolio and the model portfolio, and
summing the plurality of individual tax cost differences to give the total tax cost difference; and
storing the total tax cost difference in persistent storage.

13. The computerized method of claim 12, wherein the computing the total tax cost difference further comprises:
ordering a plurality of lots of one of the plurality of securities in order of a tax-cost per unit liquidated.

14. The computerized method of claim 12, wherein the computing a plurality of individual tax cost differences further comprises:
computing the individual tax cost difference for each over-weighted security in the plurality of securities, wherein an over-weighted security is a security that has a greater position in the actual portfolio than in the model portfolio.

15. The computerized method of claim 14, wherein the individual tax cost difference is a tax saving if that security has a position that would incur capital gains if liquidated down to a corresponding position in the model portfolio.

16. The computerized method of claim 12, wherein the computing a plurality of individual tax cost differences further comprises:
computing an individual tax cost difference for each security in the plurality of securities sold during a comparison time period.

17. The computerized method of claim 16, wherein the individual tax cost difference is a tax saving if a position of the security in the actual portfolio is brought to a value lower than the corresponding position in the model portfolio, and a portion of the sale between the level of the corresponding position in the model portfolio and the position in the actual portfolio after the sale is at a tax-loss.

18. The computerized method of claim 16, wherein the individual tax cost difference is a tax cost if a position of the security in the actual portfolio is brought to a value lower than the corresponding position in the model portfolio, and a portion of the sale between the level of the corresponding position in the model portfolio and position in the actual portfolio after the sale is at a tax-gain.

19. A system that computes a total tax cost difference between an actual portfolio of a client and a model portfolio, the system comprising:
persistent storage that stores the actual portfolio and the model portfolio; and
a tax difference module, coupled to the persistent storage, wherein the tax difference module receives client data corresponding to the actual portfolio and model data corresponding to the model portfolio, computes the total tax cost difference during a comparison time period between the actual portfolio and the model portfolio with a plurality of individual tax cost differences between positions of a plurality of securities in the actual portfolio and the model portfolio that are summed to give the total tax cost difference, and stores the total tax cost difference in persistent storage.

20. The system of claim 19, wherein the tax difference module includes a compute held tax difference module that computes the individual tax cost difference for each over-weighted security in the plurality of securities, wherein an over-weighted security is a security that has a greater position in the actual portfolio than in the model portfolio.
